(19) United States
(12) Patent Application Publication
(10) Pub. No.: US 2023/0330653 A1
(43) Pub. Date: Oct. 19, 2023

(54) THREE-WAY CONVERSION CATALYTIC ARTICLE

(71) Applicants: BASF CORPORATION; BASF SE, Ludwigshafen am Rhein (DE)

(72) Inventors: Yipeng SUN, Iselin, NJ (US); Krishnan S PILLAI, Huntsville, AL (US)

(21) Appl. No.: 18/044,345

(22) PCT Filed: Sep. 28, 2021
(86) PCT No.: PCT/EP2021/076597

§ 371 Date: Mar. 7, 2023

(30) Foreign Application Priority Data
Oct. 9, 2020 (EP) 20200940.3

(51) Int. Cl. B01J 23/10; B01J 35/04; B01D 53/94; B01J 35/00; B01J 23/44; B01J 23/46; F01N 3/10; B01J 37/02; B01J 37/08; F01N 3/28; B01J 37/04

(52) U.S. Cl. CPC B01J 35/0006; B01D 53/945; B01J 23/10; B01J 23/44; B01J 23/464; B01J 35/04; B01J 37/0228; B01J 37/0244; B01J 37/0248; B01J 37/04; B01J 37/088; F01N 3/101; F01N 3/2828; B01D 2255/1023; B01D 2255/1025; B01D 2255/2042; B01D 2255/2065; B01D 2255/20715; B01D 2255/407; B01D 2255/9022; B01D 2255/908; B01D 2257/404; B01D 2257/502; B01D 2257/702; B01D 2258/01; F01N 2330/06; F01N 2370/02

(57) ABSTRACT

Disclosed herein is a catalytic article including a first layer having at least one first platinum group metal supported on a first support, where the first support includes an alumina and a first oxygen storage component, and the first oxygen storage component includes ceria-zirconia; a second layer including at least one second platinum group metal supported on a second support, where the second support includes an alumina and a second oxygen storage component, and the second oxygen storage component includes ceria-zirconia; and a substrate . Further disclosed herein is a process for preparing the catalytic article.

### FIELD OF THE INVENTION

The presently claimed invention relates to a catalytic article useful for the treatment of the exhaust gases to reduce contaminants contained therein. Particularly, the presently claimed invention relates to a layered platinum group metal based three-way conversion catalytic article having improved thermal stability.

### BACKGROUND OF THE INVENTION

In general, the fuel economy of vehicles is improved by minimizing fuel enrichment under high load conditions. However, less fuel enrichment typically results in a rise in the exhaust temperature and thereby causing higher thermal stress for exhaust system components. This problem is more severe for heavy duty vehicles compared to light duty vehicles.

Three-way conversion (TWC) catalysts (hereinafter interchangeably referred to as three-way conversion catalyst, three-way catalyst, TWC Catalyst, and TWC) have been utilized in the treatment of exhaust gas streams from internal combustion engines for several years. Generally, in order to treat or purify the exhaust gas containing pollutants such as hydrocarbons, nitrogen oxides, and carbon monoxide, catalytic converters containing a three-way conversion catalyst are used in the exhaust gas line of an internal combustion engine. The three-way conversion catalyst is typically known to oxidize unburnt hydrocarbon and carbon monoxide and to reduce nitrogen oxides.

Though various TWC catalysts are known, it is still critical to develop catalyst technologies with increased thermal durability that can provide excellent TWC function even after severe aging.

### SUMMARY OF THE INVENTION

The presently claimed invention provides a catalytic article comprising:
a) a first layer comprising at least one first platinum group metal supported on a first support,
   wherein the first support comprises an alumina and a first oxygen storage component,
   wherein the first oxygen storage component comprises ceria-zirconia;
b) a second layer comprising at least one second platinum group metal supported on a second support,
   wherein the second support comprises an alumina and a second oxygen storage component,
   wherein the second oxygen storage component comprises ceria-zirconia; and
c) a substrate,
   wherein the total amount of alumina, calculated as Al₂O₃, from the first and second layer is ≥1.4 gram per cubic inch of the substrate;
   wherein the total amount of ceria, calculated as CeO₂, from the first and the second layer is ≥0.6 gram per cubic inch of the substrate;
   wherein the weight ratio of ceria, calculated as CeO2, present in the first layer to ceria present in the second layer is > 1.7:1;
   wherein the total amount of first or second platinum group metal is in the range of 0.001 to 0.2 gram per cubic inch of the substrate.

The presently claimed invention also provides a process for the preparation of the catalytic article of the present invention. The presently claimed invention further provides an exhaust system for internal combustion engines comprising the catalytic article of the present invention and a method of treating a gaseous exhaust stream comprising hydrocarbons, carbon monoxide, and nitrogen oxide which comprises contacting the exhaust stream with the catalytic article or the exhaust system according to the present invention.

### BRIEF DESCRIPTION OF THE DRAWINGS

In order to provide an understanding of the embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings:

FIG. 1 illustrates comparative test results for cumulative NMHC, NOx and CO emissions of an invention catalyst D and reference catalysts.

FIG. 2 illustrates comparative oxygen storage capacity of an invention catalyst D and reference catalysts.

FIG. 3A is a perspective view of a honeycomb-type substrate carrier which may comprise the catalyst composition in accordance with one embodiment of the presently claimed invention.

FIG. 3B is a partial cross-section view enlarged relative to FIG. 3A and taken along a plane parallel to the end faces of the substrate carrier of FIG. 3A, which shows an enlarged view of a plurality of the gas flow passages shown in FIG. 3A.

FIG. 4 is a cutaway view of a section enlarged relative to FIG. 3A, wherein the honeycomb-type substrate in FIG. 3A represents a wall flow filter substrate monolith.

### DETAILED DESCRIPTION

The presently claimed invention now will be described more fully hereafter. The presently claimed invention may be embodied in many different forms and should not be construed as limited to the embodiments set forth herein; rather, these embodiments are provided so that this presently claimed invention will be thorough and complete, and will fully convey the scope of the invention to those skilled in the art. No language in the specification should be construed as indicating any non-claimed element as essential to the practice of the disclosed materials and methods.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

### Definitions

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

The term “about” used throughout this specification is used to describe and account for small fluctuations. For example, the term “about” refers to less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

In the context of the present invention the term “first layer” is interchangeably used for “bottom layer” or “bottom coat”, whereas the term “second layer” is interchangeably used for “top layer” or “top coat”. The first layer is deposited at least on a part of the substrate and the second layer is deposited on at least on part of the first layer.

The term “catalyst” or “catalytic article” or “catalyst article” refers to a component in which a substrate is coated with a catalyst composition which is used to promote a desired reaction. The catalytic article can be a layered catalytic article. The term layered catalytic article refers to a catalytic article in which a substrate is coated with a catalyst composition(s) in a layered fashion. These catalytic composition(s) may be referred to as washcoat(s). Preferably the catalyst composition comprises at least one PGM as catalytically active metal.

Platinum group metals, also referred to as “PGM” are ruthenium, rhodium, palladium, osmium, iridium and platinum.

The term “three-way conversion catalyst” refers to a catalyst that simultaneously promotes a) reduction of nitrogen oxides to nitrogen and oxygen; b) oxidation of carbon monoxide to carbon dioxide; and c) oxidation of unburnt hydrocarbons to carbon dioxide and water.

The term “NO_{X}” refers to nitrogen oxide compounds, such as NO and/or NO₂.

A “support” refers to a material to which metals (e.g., PGMs), stabilizers, promoters, binders, and the like are affixed through precipitation, association, dispersion, impregnation, or other suitable methods.

The term “deposited” and “supported” are used interchangeably. Deposition of the catalytically active metal on the support can be achieved by various methods known to the person skilled in the art. These include coating techniques, impregnation techniques like incipient wetness impregnation, precipitation techniques as well as atomic deposition techniques like chemporousical vapour deposition. In these techniques a suitable precursor comprising the catalytically active metal is brought into contact with the support and thereby undergoes chemical or physical bonding with the support. The precursor comprising the catalytically active metal is thus deposited on the support. Upon interaction with the support, the precursor comprising the catalytically active metal may be transformed to another species comprising the catalytically active metal. To increase the chemical or physical bonding of the deposited species with the support different treatment steps like chemical fixing and/or thermal fixing can be performed.

The term “thermal fixing” refers to deposition of the catalytically active metal onto the respective support, e.g. via incipient wetness impregnation method, followed by the thermal calcination of the resulting catalytically active metal/support mixture. In one embodiment, the mixture is calcined for 1.0 to 3.0 hours at 400 – 700° C. with a ramp rate of 1-25° C./min.

The term “chemical fixing” refers to deposition of the catalytically active metal onto the respective support followed by a fixation using an additional reagent such as Ba-hydroxide to chemically transform the precursor comprising the catalytically active metal. As a result, catalytically active metal is chemically fixed as an insoluble component in the pores and on the surface of the support.

The term “incipient wetness impregnation” also known as capillary impregnation or dry impregnation refers to dissolving a precursor of the catalytically active metal into an aqueous or organic solution and adding the resultant catalytically active metal containing solution to support. The capillary action draws the solution into the pores of the support. The composition obtained is dried and calcined to remove the volatile components within the solution, depositing the metal on the surface of the support.

As used herein, the term “substrate” refers to a material onto which the catalyst composition is placed, typically in the form of a washcoat. The substrate is sufficiently porous to permit the passage of the gas stream being treated.

Reference to “monolithic substrate” or “honeycomb substrate” means a unitary structure that is homogeneous and continuous from inlet to outlet.

As used herein, the term “washcoat” has its usual meaning in the art of a thin, adherent coating of a catalytic or other material applied to a substrate, such as a honeycomb-type substrate. A washcoat is formed by preparing a slurry containing a certain solid content (e.g., 15-60% by weight of the slurry) of particles in a liquid vehicle, which is then coated onto a substrate and dried to provide a washcoat layer.

As used herein, “refractory metal oxide material” refers to a metal-containing oxide exhibiting chemical and physical stability at high temperatures, such as the temperatures associated with gasoline and diesel engine exhaust.

“BET surface area” has its usual meaning of referring to the Brunauer, Emmett, Teller method for determining surface area by N2 adsorption.

The term “oxygen storage component” (OSC) refers to an entity that has a multi-valence state and can actively react with reductants such as carbon monoxide (CO) and/or hydrogen under reduction conditions and then react with oxidants such as oxygen or nitrogen oxides under oxidative conditions.

OSC in the present context refers to ceria-zirconia. In one preferred embodiment, OSC refers to ceria-zirconia essentially stabilized by at least a rare earth element which may be present in oxide form such as lanthanum, yttrium, neodymium, and praseodymium.

The term “ceria-zirconia composite” refers to a mixture of ceria and zirconia which is essentially not stabilized by any rare earth element.

As used herein, the term “stream” broadly refers to any combination of flowing gas that may contain solid or liquid particulate matter.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

The object of the presently claimed invention is to develop catalyst technologies with increased thermal durability that can provide excellent TWC function even after severe high temperature aging.

The technical problem of achieving high thermal stability is being solved by synergy between the amount of alumina, amount of ceria and a particular distribution of ceria in two layers. It is found that the specific amount and distribution of ceria maintain OSC function after severe high temperature aging, a specific alumina loading provides support for PGM and maintains washcoat structural stability. Overall, the higher thermal stability helps to maintain PGM activity after severe high temperature aging, thereby Improving the conversion of HC, CO and NOx.

Accordingly, the presently claimed invention provides a catalytic article comprising:
a) a first layer comprising at least one first platinum group metal supported on a first support,
   wherein the first support comprises an alumina and a first oxygen storage component,
   wherein the first oxygen storage component comprises ceria-zirconia;
b) a second layer comprising at least one second platinum group metal supported on a second support,
   wherein the second support comprises an alumina and a second oxygen storage component,
   wherein the second oxygen storage component comprises ceria-zirconia; and
c) a substrate,
   wherein the total amount of alumina, calculated as Al₂O₃, from the first and second layer is ≥1.4 gram per cubic inch of the substrate;
   wherein the total amount of ceria, calculated as CeO₂ from the first and the second layer is ≥0.6 gram per cubic inch of the substrate;
   wherein the weight ratio of ceria present in the first layer to ceria present in the second layer is > 1.7:1;
   wherein the total amount of first or second platinum group metal is in the range of 0.001 to 0.2 gram per cubic inch of the substrate.

### Platinum Group Metals

Platinum group metals, also referred to as “PGM” are ruthenium, rhodium, palladium, osmium, iridium and platinum. The first platinum group metal is preferably selected from palladium, platinum or rhodium. The second platinum group metal is preferably selected from palladium, platinum or rhodium. More preferably, the first platinum group metal is palladium and the second platinum group metal is rhodium.

The amount of the first platinum group metal or the amount of the second group platinum metal is in the range of 0.001 to 0.2 gram per cubic inch of the substrate. Preferably, the amount of the first platinum group metal is in the range of 0.029 to 0.174 gram per cubic inch (50 to 300 grams per cubic foot) of the substrate. Preferably, the amount of the second platinum group metal is in the range of 0.001 to 0.017 gram per cubic inch (2.0 to 30 grams per cubic foot) of the substrate.

### Support

### A. Alumina (Refractory Metal Oxide Component):

In general, refractory metal oxides include alumina, silica, zirconia, titania, ceria, and physical mixtures or chemical mixtures thereof, including atomically doped combinations. The refractory metal oxide component can be high surface area refractory metal oxide support which refer specifically to support particles having pores larger than 20 Å and a wide pore distribution.

In the present invention, the refractory metal oxide component used is an alumina. The term “alumina” refers to stabilized or non-stabilized aluminium oxide. Stabilized aluminium oxide and non-stabilized aluminium oxide can be present in different phase modifications. The stabilized aluminium oxide is a complex oxide comprising Al₂O₃ and one or more dopants selected from rare earth metal oxides, alkaline metal oxides, alkaline earth metal oxides, silicon dioxide or any combination of the aforementioned. Preferable dopants are lanthanum oxide (La₂O₃), cerium oxide (CeO₂), zirconium oxide (ZrO₂), barium oxide BaO), neodymium oxide (Nd2O3), combinations of lanthanum oxide and zirconium oxide, combinations of barium oxide and lanthanum oxide, combinations of barium oxide, lanthanum oxide and neodymium oxide or combinations of cerium oxide and zirconium oxide. The dopants can impart different properties on the aluminium oxide. The dopants can retard undesired phase transformations of the aluminium oxide, can stabilize the surface area, can introduce defect sites and/or change the acidity of the aluminium oxide surface.

Exemplary alumina may include large pore boehmite, gamma-alumina, and delta/theta alumina. Useful commercial alumina includes activated alumina(s), such as high bulk density gamma-alumina, low or medium bulk density large pore gamma-alumina, and low bulk density large pore boehmite and gamma-alumina. Such materials are generally considered as providing durability to the resulting catalyst. High surface area alumina supports, also referred to as “gamma alumina” or “activated alumina,” typically exhibit a BET surface area of fresh material in excess of 60 square meters per gram (“m²/g”), often up to about 300 m²/g or higher. Such activated alumina is usually a mixture of the gamma and delta phases of alumina, but may also contain substantial amounts of eta, kappa and theta alumina phases.

The BET surface area of alumina can range from about 100 to about 150 m²/g.

The total amount of alumina calculated as Al₂O₃ in the first layer is about 20 to 70 wt. %, based on the total weight of the first layer and total amount of alumina in the second layer is about 20 to 70 wt. %, based on the total weight of the second layer.

Alumina can be doped with a dopant selected from lanthana, ceria, ceria-zirconia, zirconia, lanthana-zirconia, baria, baria-lanthana, baria-lanthana-neodymia, or combinations thereof. The amount of dopant in alumina is in the range of 0.01 to 15 wt. % of the total weight of the alumina.

### B. Oxygen Storage Component:

The oxygen storage component comprises ceria-zirconia. The term ceria-zirconia refers to a complex oxide or mixed oxide comprising CeO₂ and ZrO₂. In one embodiment, the oxygen storage component is a solid solution containing CeO₂ and ZrO₂ which may form a single phase as detected by XRD. Beside CeO₂ and ZrO₂, the ceria-zirconia may comprise additional rare earth metal oxides different from CeO₂ and ZrO₂. The presence of rare earth metal oxide provides stability to the ceria-zirconia mixed metal oxides. In the context of the present invention, exemplary oxygen storage component includes ceria-zirconia-lanthana, ceria-zirconia-yttria, ceria-zirconia-lanthana-yttria, ceria-zirconia-neodymia, ceria-zirconia-praseodymia, ceria-zirconia-lanthana-neodymia, ceria-zirconia-lanthana-praseodymia, ceria-zirconia-lanthana-neodymia-praseodymia, or any combination thereof.

Preferably, the amount of CeO₂ in the oxygen storage component is in the range of 20 to 50 weight % based on the weight of the oxygen storage component.

The oxygen storage component present in the first and/or the second layer are same. Preferably, the first oxygen storage component comprises ceria-zirconia stabilized by lanthana (La₂O₃). Preferably, the second oxygen storage component comprises ceria-zirconia stabilized by lanthana (La₂O₃).

Total amount of oxygen storage component in the first layer is about 30 to 80 wt. %, based on the total weight of the first layer and the total amount of oxygen storage component in the second layer is about 20 to 70 wt. %, based on the total weight of the second layer.

The amount of ceria in the first oxygen storage component is about 20 to about 45 wt.%, based on total weight of the first oxygen storage component. The amount of ceria in the second oxygen storage component is about 20 to about 45 wt.%, based on total weight of the second oxygen storage component.

The amount of ceria, calculated as CeO₂ in the first layer is about 10 to 50 wt. %, whereas the amount of ceria in the second layer is about 10 to 50 wt. %.

The amount of oxygen storage component present in the first layer is preferably in the range of 30 to 60 wt. % based on the total weight of the first layer. The amount of oxygen storage component present in the second layer is preferably in the range of 30 to 60 wt. % based on the total weight of the second layer.

### C. Ceria-zirconia Composite:

Exemplary ceria-zirconia composite is a mixture of ceria and zirconia. In one embodiment, the composite is mixed oxide in which each oxide has its distinct chemical and physical state, however, the oxides can interact through their interface. Any physical state of CeO₂ or the combination of the states can exist or coexist on the surface of zirconia or in the bulk. The surface CeO₂ modification of zirconia can in the form of discrete moieties (particles or clusters) or forms a layer of ceria that covers the surface of zirconia partially or completely.

In one embodiment, the ceria-zirconia composite contains 50% by weight of ceria, based on total weight of the ceria-zirconia composite. The amount of ceria-zirconia composite in the second layer is about 1.0 to 25 wt. %. The ceria-zirconia composite may be added as a binder in the catalytic article of the present invention.

### Substrate

The substrate of the catalytic article of the presently claimed invention may be constructed of any material typically used for preparing automotive catalysts. In one embodiment, the substrate is a ceramic substrate, metal substrate, ceramic foam substrate, polymer foam substrate or a woven fiber substrate. In one embodiment, the substrate is a ceramic or a metal monolithic honeycomb structure.

The substrate provides a plurality of wall surfaces upon which washcoats comprising the catalyst compositions described herein above are applied and adhered, thereby acting as a carrier for the catalyst compositions.

Exemplary metallic substrates include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt. % of the alloy. e.g. 10-25 wt. % of chromium, 3-8% of aluminium, and up to 20 wt. % of nickel. The alloys may also contain small or trace amounts of one or more metals such as manganese, copper, vanadium, titanium and the like. The surface of the metal substrate may be oxidized at high temperature, e.g., 1000° C. and higher, to form an oxide layer on the surface of the substrate, improving the corrosion resistance of the alloy and facilitating adhesion of the washcoat layer to the metal surface.

Ceramic materials used to construct the substrate may include any suitable refractory material, e.g., cordierite, mullite, cordierite-alumina, silicon nitride, zircon mullite, spodumene, alumina-silica magnesia, zircon silicate, sillimanite, magnesium silicates, zircon, petalite, alumina, aluminosilicates and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which are of any suitable cross-sectional shape, such as trapezoidal, rectangular, square, sinusoidal, hexagonal, oval, circular, and the like. Such structures contain from about 60 to about 1200 or more gas inlet openings (i.e., “cells”) per square inch of cross section (cpsi), more usually from about 300 to 900 cpsi. The wall thickness of flow-through substrates can vary, with a typical range being between 0.002 and 0.1 inches. A representative commercially available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry. In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used as wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls. In one embodiment, the substrate has a flow through ceramic honeycomb structure, a wall-flow ceramic honeycomb structure, or a metal honeycomb structure.

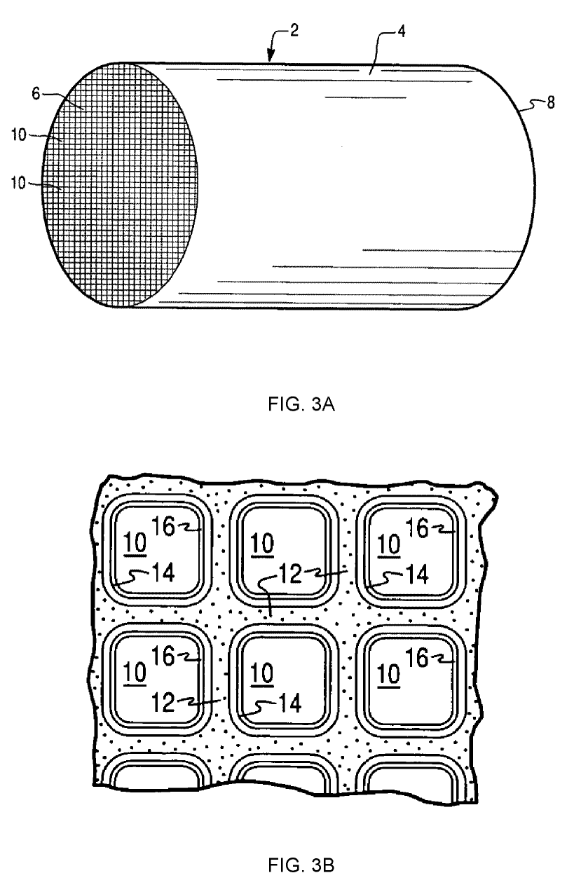

FIGS. 3A and 3B illustrate an exemplary substrate 2 in the form of a flow-through substrate coated with washcoat compositions as described herein. Referring to FIG. 3A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 3B, flow passages 10 are formed by walls 12 and extend through substrate 2 from upstream end face 6 to downstream end face 8, the passages 10 being unobstructed so as to permit the flow of a fluid, e.g., a gas stream, longitudinally through substrate 2 via gas flow passages 10 thereof. As more easily seen in FIG. 3B, walls 12 are so dimensioned and configured that gas flow passages 10 have a substantially regular polygonal shape. As shown, the washcoat compositions can be applied in multiple, distinct layers if desired. In the illustrated embodiment, the washcoats consist of a discrete first washcoat layer 14 adhered to the walls 12 of the substrate member and a second discrete washcoat layer 16 coated over the first washcoat layer 14. In one embodiment, the presently claimed invention is also practiced with two or more (e.g., 3, or 4) washcoat layers and is not limited to the illustrated two-layer embodiment.

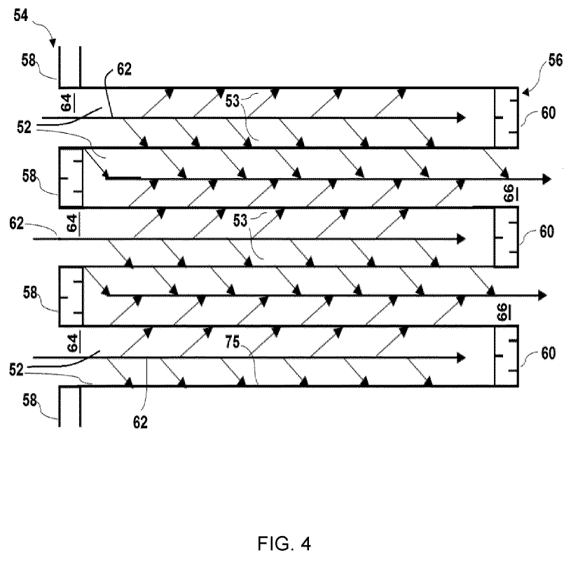

FIG. 4 illustrates an exemplary substrate 2 in the form of a wall flow filter substrate coated with a washcoat composition as described herein. As seen in FIG. 4, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58 and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalysed in that the wall of said element has thereon or contained therein one or more catalytic materials. Catalytic materials may be present on the inlet side of the element wall alone, the outlet side alone, both the inlet and outlet sides, or the wall itself may consist all, or in part, of the catalytic material. This invention includes the use of one or more layers of catalytic material on the inlet and/or outlet walls of the element.

### Washcoat/s on Substrate

### First Layer (bottom Coat)

The bottom coat is deposited on the substrate. Preferably, the bottom coat covers 90 to 100% of the surface of the substrate. More preferably, the bottom coat covers 95 to 100% of the surface of the substrate and even more preferably, the bottom coat covers the whole accessible surface of the substrate. The term “accessible surface” refers to the surface of the substrate which can be covered with the conventional coating techniques used in the field of catalyst preparation like impregnation techniques.

The first layer comprises at least one first platinum group metal supported on a first support. The first platinum group metal is selected from palladium, platinum, and rhodium. Preferably, the first platinum group metal is palladium. Preferably, the second platinum group metal is rhodium. The amount of the first platinum group metal is in the range of 0.001 to 0.2 gram per cubic inch of the substrate. Preferably, the amount of the first platinum group metal is in the range of 0.029 to 0.174 gram per cubic inch (50 to 300 grams per cubic foot) of the substrate.

Preferably, the first support comprises an alumina and a first oxygen storage component. The first oxygen storage component comprises ceria-zirconia. Alumina used as a support may comprises a dopant selected from lanthana, ceria, ceria-zirconia, zirconia, lanthana-zirconia, baria, baria-lanthana, baria-lanthana-neodymia, or combinations thereof. The amount of ceria in the first oxygen storage component is about 20 to about 45 wt.%, based on total weight of the first oxygen storage component. Preferably, the amount of ceria in the first oxygen storage component is about 30 to about 45 wt.%, based on total weight of the first oxygen storage component. More preferably, the amount of ceria is 40 %, based on the total weight of the first oxygen storage component. The first layer may comprise at least one alkaline earth metal oxide comprising barium oxide, strontium oxide, or any combination thereof, in an amount of 1.0 to 20 wt. %, based on the total weight of the first layer. The first layer may further comprises barium and zirconium.

### Second Layer (Top Coat)

The second layer comprises at least one second platinum group metal supported on a second support. The second platinum group metal is selected from palladium, platinum, and rhodium. Preferably, the second platinum group metal is rhodium. The amount of the second platinum group metal is in the range of 0.001 to 0.2 gram per cubic inch of the substrate. Preferably, the amount of the second platinum group metal is in the range of 0.001 to 0.017 gram per cubic inch (2.0 to 30 grams per cubic foot) of the substrate.

The second support comprises an alumina and a second oxygen storage component. Alumina used as a support may comprises a dopant selected from lanthana, ceria, ceria-zirconia, zirconia, lanthana-zirconia, baria, baria-lanthana, baria-lanthana-neodymia, or combinations thereof. The second oxygen storage component comprises ceria-zirconia. The amount of ceria in the second oxygen storage component is about 20 to about 45 wt.%, based on total weight of the second oxygen storage component. Preferably, the amount of ceria in the first oxygen storage component is about 30 to about 45 wt.%, based on total weight of the first oxygen storage component More preferably, the amount of ceria is 40 %, based on the total weight of the second oxygen storage component. The second layer may further comprise a ceria-zirconia composite.

The total amount of alumina, calculated as Al₂O₃, from the first and second layer is ≥1.4 gram per cubic inch of the substrate. Preferably, the total amount of alumina from the first and second layer is 1.4 to 2.5 gram per cubic inch of the substrate.

The total amount of ceria calculated as CeO₂ from the first and the second layer is ≥0.6 gram per cubic inch of the substrate. Preferably, the total amount of ceria from the first and the second layer is 0.6 to 1 gram per cubic inch of the substrate.

The weight ratio of ceria present in the first layer to ceria present in the second layer is > 1.7:1. Preferably, the weight ratio of ceria present in the first layer to ceria present in the second layer is in the range of about 1.7:1 to about 3.5:1.

The total amount of first or second platinum group metal is in the range of 0.001 to 0.2 gram per cubic inch of the substrate.

### Preparation of the Catalytic Article

In accordance with still another aspect, the presently claimed invention provides a process for preparing the catalytic article which comprises:
preparing a first layer slurry comprising a) at least one first platinum group metal, b) an alumina, c) and a first oxygen storage component comprising ceria-zirconia;
depositing the first layer slurry on a substrate to obtain a first layer;
preparing a second layer slurry comprising a) at least one second platinum group metal, b) an alumina, and c) a second oxygen storage component comprising ceria-zirconia; and
depositing the second layer slurry on the first layer to obtain a second layer followed by calcination at a temperature ranging from 400 to 700° C., wherein the step of preparing the first layer slurry or second layer slurry comprises a technique selected from incipient wetness impregnation, incipient wetness co-impregnation, and post-addition.

In the process of preparing the catalytic article, the first layer is prepared using an alumina and a first oxygen storage component comprising ceria-zirconia and the second layer is prepared using alumina, the second oxygen storage component comprising ceria-zirconia and optionally a ceria-zirconia component. The total amount of ceria from the first and second layer is 0.6 to 1 gram per cubic inch. The total amount of alumina from the first and second layer is 1.4 to 2.5 gram per cubic inch. The weight ratio of ceria present in the first layer to ceria present in the second layer is in the range of 1.7:1 to 3.5:1.

The process may involve a pre-step of thermal or chemical fixing of platinum or palladium or both on supports.

### Substrate Coating

The above-noted catalyst compositions are typically prepared in the form of catalyst particles as noted above. These catalyst particles are mixed with water to form a slurry for purposes of coating a catalyst substrate, such as a honeycomb-type substrate. In addition to the catalyst particles, the slurry may optionally contain a binder in the form of alumina, silica, zirconium acetate, zirconia, or zirconium hydroxide, associative thickeners, and/or surfactants (including anionic, cationic, non-ionic, or amphoteric surfactants). Other exemplary binders include boehmite, gamma-alumina, or delta/theta alumina, as well as silica sol. When present, the binder is typically used in an amount of about 1-5 wt.% of the total washcoat loading. Addition of acidic or basic species to the slurry is carried out to adjust the pH accordingly. For example, in some embodiments, the pH of the slurry is adjusted by the addition of ammonium hydroxide, aqueous nitric acid, or acetic acid. A typical pH range for the slurry is about 3 to 12.

The slurry can be milled to reduce the particle size and enhance particle mixing. The milling is accomplished in a ball mill, continuous mill, or other similar equipment, and the solids content of the slurry may be, e.g., about 20-60 wt.%, more particularly about 20-40 wt.%. In one embodiment, the post-milling slurry is characterized by a D90 particle size of about 3 to about 40 microns, preferably 10 to about 30 microns, more preferably about 10 to about 15 microns. The D₉₀ is determined using a dedicated particle size analyzer. The equipment employed in this example uses laser diffraction to measure particle sizes in small volume slurry. The D₉₀, typically with units of microns, means 90% of the particles by number have a diameter less than that value.

The slurry is coated on the catalyst substrate using any washcoat technique known in the art. In one embodiment, the catalyst substrate is dipped one or more times in the slurry or otherwise coated with the slurry. Thereafter, the coated substrate is dried at an elevated temperature (e.g., 100-150° C.) for a period (e.g., 10 min - 3 hours) and then calcined by heating, e.g., at 400-700° C., typically for about 10 minutes to about 3 hours. Following drying and calcining, the final washcoat coating layer is viewed as essentially solvent-free. After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

In certain embodiments, the coated substrate is aged, by subjecting the coated substrate to heat treatment. In one embodiment, aging is done at a temperature of about 850° C. to about 1050° C. in an environment of 10 vol. % water in an alternating hydrocarbon / air feed for 50 – 75 hours. Aged catalyst articles are thus provided in certain embodiments. In certain embodiments, particularly effective materials comprise metal oxide-based supports (including, but not limited to substantially 100% ceria supports) that maintain a high percentage (e.g., about 95-100%) of their pore volumes upon aging (e.g., at about 850° C. to about 1050° C., 10 vol. % water in an alternating hydrocarbon / air feed, 50 – 75 hours aging).

### Emission Treatment System

The presently claimed invention in another aspect also provides an exhaust system for internal combustion engines, the system comprises the catalytic article as described herein above. The catalytic article of the present invention can be used as the sole catalyst component of exhaust system, where the catalytic article of the invention is used downstream from an engine and positioned to receive an exhaust gas from the engine. The catalytic article of the invention can also be used as part of an integrated exhaust system comprising one or more additional components for the treatment of exhaust gas emissions.

For example, the exhaust system also known as emission treatment system may further comprise close coupled TWC catalyst, underfloor catalyst, catalysed soot filter (CSF) component, and/or a selective catalytic reduction (SCR) catalytic article. The preceding list of components is merely illustrative and should not be taken as limiting the scope of the invention.

The catalytic article may be placed in a close-coupled position. Close-coupled catalysts are placed close to an engine to enable them to reach reaction temperatures as soon as possible. In general, the close-coupled catalyst is placed within three feet, more specifically, within one foot of the engine, and even more specifically, less than six inches from the engine. Close-coupled catalysts are often attached directly to the exhaust gas manifold. Due to their proximity to the engine, close-coupled catalysts are required to be stable at high temperatures.

The presently claimed invention in another aspect also provides a method of reducing hydrocarbons, carbon monoxide, and nitrogen oxide levels in a gaseous exhaust stream, the method comprising contacting the gaseous exhaust stream with the catalytic article or an exhaust system as described herein above to reduce the levels of hydrocarbons, carbon monoxide, and nitrogen oxide in the exhaust gas.

The presently claimed invention in another aspect also provides use of the catalytic article as described herein above for purifying a gaseous exhaust stream comprising hydrocarbons, carbon monoxide, and nitrogen oxide.

The invention is further described by the following embodiments. The features of each of the embodiments are combinable with any of the other embodiments where appropriate and practical.

### Embodiment 1

A catalytic article comprising:
a) a first layer comprising at least one first platinum group metal supported on a first support,
   wherein the first support comprises an alumina and a first oxygen storage component,
   wherein the first oxygen storage component comprises ceria-zirconia;
b) a second layer comprising at least one second platinum group metal supported on a second support,
   wherein the second support comprises an alumina and a second oxygen storage component,
   wherein the second oxygen storage component comprises ceria-zirconia; and
c) a substrate,
   wherein the total amount of alumina, calculated as Al₂O₃, from the first and second layer is ≥1.4 gram per cubic inch of the substrate;
   wherein the total amount of ceria, calculated as CeO₂ from the first and the second layer is ≥0.6 gram per cubic inch of the substrate;
   wherein the weight ratio of ceria present in the first layer to ceria present in the second layer is > 1.7:1;
   wherein the total amount of first or second platinum group metal is in the range of 0.001 to 0.2 gram per cubic inch of the substrate.

### Embodiment 2

The catalytic article according to the embodiment 1, wherein the first or the second platinum group metal is selected from palladium, platinum, and rhodium.

### Embodiment 3

The catalytic article according to any of the embodiments 1 to 2, wherein the first platinum group metal is palladium.

### Embodiment 4

The catalytic article according to any of the embodiments 1 to 3, wherein the second platinum group metal is rhodium.

### Embodiment 5

The catalytic article according to any of the embodiments 1 to 4, wherein alumina comprises a dopant selected from lanthana, ceria, ceria-zirconia, zirconia, lanthana-zirconia, baria, baria-lanthana, baria-lanthana-neodymia, or combinations thereof.

### Embodiment 6

The catalytic article according to any of the embodiments 1 to 5, wherein the amount of ceria in the first oxygen storage component is about 20 to about 45 wt.%, based on total weight of the first oxygen storage component.

### Embodiment 7

The catalytic article according to any of the embodiments 1 to 6, wherein the amount of ceria in the second oxygen storage component is about 20 to about 45 wt.%, based on total weight of the second oxygen storage component.

### Embodiment 8

The catalytic article according to any of the embodiments 1 to 7, wherein the total amount of alumina from the first and second layer is 1.4 to 2.5 gram per cubic inch of the substrate, and wherein the total amount of ceria from the first and the second layer is 0.6 to 1.0 gram per cubic inch of the substrate.

### Embodiment 9

The catalytic article according to any of the embodiments 1 to 8, wherein the weight ratio of ceria present in the first layer to ceria present in the second layer is in the range of about 1.7:1 to about 3.5:1.

### Embodiment 10

The catalytic article according to any of the embodiments 1 to 9, wherein the second layer comprises a ceria-zirconia composite.

### Embodiment 11

The catalytic article according to any of the embodiments 1 to 10, wherein the first layer comprises at least one alkaline earth metal oxide comprising barium oxide, strontium oxide, or any combination thereof, in an amount of 1.0 to 20 wt. %, based on the total weight of the first layer.

### Embodiment 12

The catalytic article according to any of the embodiments 1 to 11, wherein the substrate is a ceramic substrate, metal substrate, ceramic foam substrate, polymer foam substrate or a woven fibre substrate.

### Embodiment 13

The catalytic article according to any of the embodiments 1 to 12, wherein the first layer further comprises barium and zirconium; and the second layer comprises ceria-zirconia composite.

### Embodiment 14

The catalytic article according to the presently claimed invention, wherein the catalytic article comprises a) a first layer comprising at least one first platinum group metal supported on a first support, wherein the first platinum group metal is palladium, wherein the first support comprises alumina and the first oxygen storage component comprising ceria-zirconia, wherein the amount of ceria is 40%, based on the total weight of the first oxygen storage component; b) a second layer comprising at least one second platinum group metal supported on a second support, wherein the second platinum group metal is rhodium, wherein the second support comprises alumina-ceria and the second oxygen storage component comprising ceria-zirconia, wherein the amount of ceria is 40%, based on the total weight of the second oxygen storage component; and c) a substrate,
wherein the total amount of alumina, calculated as Al₂O₃, from the first and second layer is 1.4 to 2.5 gram per cubic inch of the substrate,
wherein the total amount of ceria, calculated as CeO₂, from the first and the second layer is 0.6 to 1.0 gram per cubic inch of the substrate,
wherein the weight ratio of ceria present in the first layer to ceria present in the second layer is in the range of 1.7:1 to 3.5:1,
wherein the amount of first or second platinum group metal is in the range of 0.001 to 0.2 gram per cubic inch of the substrate.

### Embodiment 15

The catalytic article according to the presently claimed invention, wherein the catalytic article comprises a) a first layer comprising at least one first platinum group metal in an amount of 0.029 to 0.174 gram per cubic inch of the substrate supported on a first support, wherein the first platinum group metal is palladium, wherein the first support comprises alumina and the first oxygen storage component comprising ceria-zirconia, wherein the amount of ceria is 40%, based on the total weight of the first oxygen storage component; b) a second layer comprising at least one second platinum group metal in an amount of 0.001 to 0.017 gram per cubic inch of substrate supported on a second support, wherein the second platinum group metal is rhodium, wherein the second support comprises alumina-ceria and the second oxygen storage component comprising ceria-zirconia, wherein the amount of ceria is 40%, based on the total weight of the second oxygen storage component; and c) a substrate,
wherein the total amount of alumina from the first and second layer is 1.4 to 2.5 gram per cubic inch of the substrate,
wherein the total amount of ceria from the first and the second layer is 0.6 to 1 gram per cubic inch of the substrate,
wherein the weight ratio of ceria present in the first layer to ceria present in the second layer is in the range of 1.7:1 to 3.5:1.

### Embodiment 16

The catalytic article according to the presently claimed invention, wherein the catalytic article comprises: a) a first layer comprising at least one first platinum group metal in an amount of 0.029 to 0.174 gram per cubic inch of the substrate supported on a first support, wherein the first platinum group metal is palladium, wherein the first support comprises alumina and the first oxygen storage component comprising ceria-zirconia, wherein the amount of ceria is 40%, based on the total weight of the first oxygen storage component; b) a second layer comprising at least one second platinum group metal in an amount of 0.001 to 0.017 gram per cubic inch of substrate supported on a second support, wherein the second platinum group metal is rhodium, wherein the second support comprises alumina-ceria and the second oxygen storage component comprising ceria-zirconia, wherein the amount of ceria is 40%, based on the total weight of the second oxygen storage component; and c) a substrate,
wherein the total amount of alumina, calculated as Al₂O₃, from the first and second layer is 1.4 to 2.5 gram per cubic inch of the substrate,
wherein the total amount of ceria, calculated as CeO₂, from the first and the second layer is 0.6 to 1 gram per cubic inch of the substrate,
wherein the weight ratio of ceria present in the first layer to ceria present in the second layer is in the range of 1.7:1 to 3.5:1,
wherein the first layer comprises barium and zirconium; and the second layer comprises ceria-zirconia composite.

Aspects of the presently claimed invention are more fully illustrated by the following examples, which are set forth to illustrate certain aspects of the present invention and are not to be construed as limiting thereof.

The examples provided herein below have the following features:

TABLE 1

Composition of catalyst

| | Invention Catalyst D | Comparison Catalyst A | Comparison Catalyst B | Comparison Catalyst C |
|---|---|---|---|---|
| Alumina (g/in³) | 1.65 | 1.57 | 1.17 | 0.98 |
| Total Ceria (g/in³) | 0.79 | 0.34 | 0.82 | 1.08 |
| Ratio of ceria in bottom coat to ceria in top coat | 1.83 | 0.20 | 1.93 | 1.57 |

### Example 1: Preparation of Two-Layered Catalytic Article (Invention Catalyst D)

A Pd/Rh catalytic article with a PGM loading of 97 g/ft³ (Pt/Pd/Rh = 0/81/16) was prepared. The invention catalyst D is a two-layer washcoat architecture coated onto an oval monolith cordierite substrate having dimensions of 5.16″ and 3.54″ in diameter and 5.05″ in length, a cell density of 900 cpsi, and a wall thickness of 2.0 mils.

### Preparation of a Bottom Coat:

A slurry containing about 35.1 wt.% of the refractory alumina with 4.0 wt.% lanthanum oxide, 49.6 wt.% of the stabilized ceria-zirconia OSC with approximately 40 wt.% ceria, barium acetate to yield 11.6 wt.% of BaO, zirconium acetate to yield 1.9 wt.% of ZrO₂, and 1.8 wt.% of Pd(metallic), was coated onto the substrate. The washcoat loading of the bottom coat was about 2.59 g/in³ after calcination at 550° C. for 1 hour in air.

### Preparation of a Top Coat:

A slurry containing about 56.3 wt.% of the refractory alumina with 8 wt% ceria, 33.1 wt.% of stabilized ceria-zirconia OSC with approximately 40 wt.% ceria, 9.9 wt.% of a ceria-zirconia composite with approximately 50 wt.% ceria, and 0.61 wt.% of Rh, was coated over the bottom coat. The washcoat loading of the top coat was about 1.51 g/in³ after calcination at 550° C. for 1 hour in air.

### Example 2: Comparative Catalytic Article A

A Pd/Rh catalytic article with a PGM loading of 97 g/ft³ (Pt/Pd/Rh = 0/81/16) was prepared. The catalytic article A is a two-layer washcoat architecture coated onto an oval monolith cordierite substrate having dimensions of 5.16″ and 3.54″ in diameter and 5.05″ in length, a cell density of 900 cpsi, and a wall thickness of 2.0 mils.

### Preparation of a Bottom Coat:

A slurry containing about 65 wt.% of the refractory alumina with 1.3 wt% lanthanum oxide, 10.8 wt.% of the stabilized ceria-zirconia OSC with approximately 28.5 wt.% ceria, barium acetate to yield 5.4 wt.% of BaO, strontium acetate to yield 5.4 wt.% of SrO, zirconium acetate to yield 5.4 wt.% of ZrO₂, lanthanum nitrate to yield 5.4 wt.% of La₂O₃ and 2.5 wt.% of Pd was coated onto the substrate. The washcoat loading of the bottom coat was about 1.85 g/in³ after calcination at 550° C. for 1 hour in air.

### Preparation of a Top Coat:

A slurry containing about 26.5 wt.% of the refractory alumina with 4 wt% lanthanum oxide, 66.3 wt.% of stabilized ceria-zirconia OSC with approximately 28.5 wt.% ceria, zirconium acetate to yield 6.6 wt.% of ZrO₂, and 0.62 wt.% of Rh was coated over the bottom coat. The washcoat loading of the top coat was about 1.51 g/in³ after calcination at 550° C. for 1 hour in air.

### Example 3: Comparative Catalytic Article B

A Pd/Rh catalytic article with a PGM loading of 97 g/ft³ (Pt/Pd/Rh = 0/81/16) was prepared. The catalyst B is a two-layer washcoat architecture coated onto an oval monolith cordierite substrate having dimensions of 5.16″ and 3.54″ in diameter and 5.05″ in length, a cell density of 900 cpsi, and a wall thickness of 2.0 mils.

### Preparation of a Bottom Coat:

A slurry containing about 28.1 wt.% of the refractory alumina with 4 wt% lanthanum oxide, 51.2 wt.% of the stabilized ceria-zirconia OSC with approximately 40 wt.% ceria, 9.7 wt.% of a ceria-zirconia composite with approximately 50 wt.% ceria, 1.5 wt.% of a zirconia-yttrium composite with approximately 40 wt.% yttrium, lanthanum nitrate to yield 0.5 wt.% of La₂O₃, barium acetate and barium sulfate to yield 6.4 wt.% of BaO, zirconium acetate to yield 0.3 wt.% of ZrO₂, colloidal alumina binder to yield 0.5 wt.% of Al₂O₃, and 1.8 wt.% of Pd was coated onto the substrate. The washcoat loading of the bottom coat was about 2.16 g/in³ after calcination at 550° C. for 1 hour in air.

### Preparation of a Top Coat:

A slurry containing about 43.8 wt.% of the refractory alumina with 1.7 wt% lanthanum oxide, 51.1 wt.% of stabilized ceria-zirconia OSC with approximately 40 wt.% ceria, barium sulfate and barium hydroxide to yield 2.1 wt.% of BaO, colloidal alumina binder to yield 1.8 wt.% of Al₂O₃, 0.60 wt.% of Pd and 0.68 wt.% of Rh was coated over the bottom coat. The washcoat loading of the top coat was about 1.38 g/in³ after calcination at 550° C. for 1 hour in air.

### Example 4: Comparative Catalytic Article C

A Pd/Rh catalytic article with a PGM loading of 97 g/ft³ (Pt/Pd/Rh = 0/81/16) was prepared. The catalytic article C is a two-layer washcoat architecture coated onto an oval monolith cordierite substrate having dimensions of 5.16″ and 3.54″ in diameter and 5.05″ in length, a cell density of 900 cpsi, and a wall thickness of 2.0 mils.

### Preparation of a Bottom Coat:

A slurry containing about 20.9 wt.% of the refractory alumina with 4 wt% lanthanum oxide, 63.7 wt.% of the stabilized ceria-zirconia OSC with approximately 40 wt.% ceria, barium acetate to yield 11.6 wt.% of BaO, zirconium acetate to yield 1.9 wt.% of ZrO₂, and 1.8 wt.% of Pd was coated onto the substrate. The washcoat loading of the bottom coat was about 2.59 g/in³ after calcination at 550° C. for 1 hour in air.

### Preparation of a Top Coat:

A slurry containing about 33.1 wt.% of the refractory alumina with 8 wt% ceria, 56.3 wt.% of stabilized ceria-zirconia OSC with approximately 40 wt.% ceria, 9.9 wt.% of a ceria-zirconia composite with approximately 50 wt.% ceria, and 0.61 wt.% of Rh was coated over the bottom coat. The washcoat loading of the top coat was about 1.51 g/in³ after calcination at 550° C. for 1 hour in air.

### Example 5: Catalytic Article E

Catalytic article E is a Rh catalytic article with a PGM loading of 3 g/ft³ (Pt/Pd/Rh = 0/0/3). The catalyst E is a single-layer washcoat architecture coated onto an oval monolith cordierite substrate having dimensions of 5.16″ and 3.54″ in diameter and 5.05″ in length, a cell density of 400 cpsi, and a wall thickness of 4 mils. A slurry containing about 63.1 wt.% of the refractory Al₂O₃, 32.0 wt.% of the stabilized ceria-zirconia OSC, barium acetate to yield 1.5 wt.% of BaO, zirconium acetate to yield 0.3 wt.% of ZrO₂, strontium acetate to yield 1.5 wt.% SrO and 0.06 wt.% of Rh was coated onto the substrate. The washcoat loading was about 2.8 g/in³ after calcination at 550° C. for 1 hour in air.

### Example 6: Testing of Catalytic Articles

Catalytic articles A, B, C and D were aged using a 4-mode exothermic aging protocol with effective catalyst temperature of 1022° C. for 150 hours on an engine setup. Catalytic article E was aged using a 4-mode exothermic aging protocol with effective catalyst temperature of 910° C. for 100 hrs. on an engine setup. The engine-out gas feed composition alternates between rich and lean to simulate typical vehicle operating conditions.

The emission performance was tested using a 2.0 L turbocharged ULEV70 vehicle with a close coupled (CC) + underfloor (UF) emissions control system configuration operating under the FTP-75 test protocol. Catalyst A, B, C and D were tested as CC catalyst, while catalyst E was used as a common UF catalyst.

### RESULTS

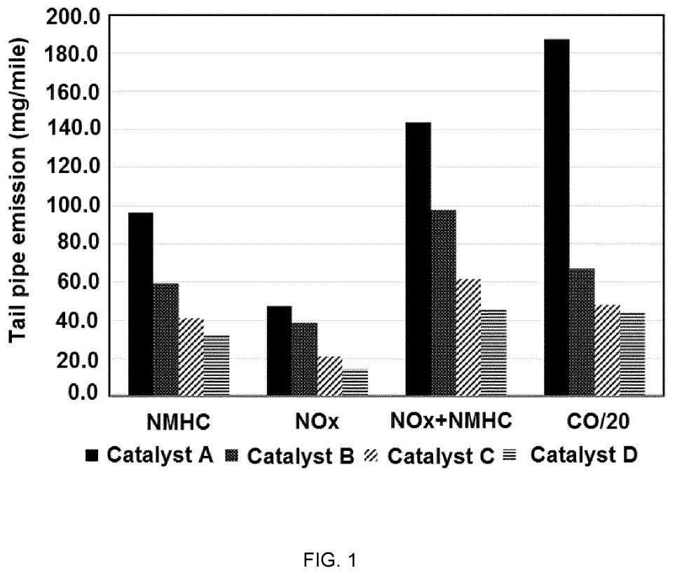

The results are demonstrated in FIG. 1. The invention catalytic article D has lowest tail pipe emission for all three emission species (NMHC, NOx and CO) among four CC catalysts (A, B, C, D) after high temperature aging. It achieved up to ~68% reduction in combined NMHC+NOₓ and up to ~76% reduction in CO compared to the comparison catalysts.

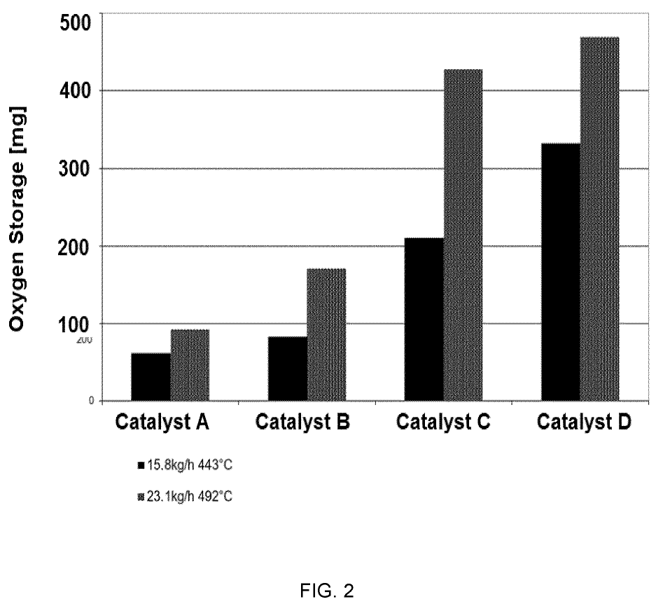

Further, the oxygen storage capacity (OSC) of aged catalytic articles was measured on an engine setup. The results are shown in FIG. 2. The invention catalytic article D shows highest OSC even though other catalysts as prepared have either similar (Catalyst B) or more (Catalyst C) OSC materials.

The results clearly show that there are three critical features for reducing the emissions and improving the oxygen storage capacity of the catalytic article, thereby improving the thermal stability. i.e. the total amount of alumina, total amount of ceria and the ratio of ceria from the first layer and the second layer (distribution of ceria in two layers).

It is observed that:
a) The catalytic article A performs less efficient though alumina is used in desired amount. This may be due to lower amount of total ceria and lower ratio of ceria from the first layer and the second layer.
b) The catalytic article B though exhibits the desired amount of total ceria and desired ratio of ceria from the first layer and the second layer but found to be less efficient as the total amount of alumina is lower than the required one.
c) The catalytic article C which has desired amount of total ceria but lower total amount of alumina and the lower ratio of ceria from the first layer and the second layer, performs less efficient.

Reference throughout this specification to “one embodiment,” “certain embodiments,” “one or more embodiments” or “an embodiment” means that a particular feature, structure, material, or characteristic described in connection with the embodiment is included in at least one embodiment of the presently claimed invention. Thus, the appearances of the phrases such as “in one or more embodiments,” “in certain embodiments,” “in some embodiments,” “in one embodiment,” or “in an embodiment” in various places throughout this specification are not necessarily referring to the same embodiment of the presently claimed invention. Furthermore, the particular features, structures, materials, or characteristics may be combined in any suitable manner in one or more embodiments. All of the various embodiments, aspects, and options disclosed herein can be combined in all variations, regardless of whether such features or elements are expressly combined in a specific embodiment description herein. This presently claimed invention is intended to be read holistically such that any separable features or elements of the disclosed invention, in any of its various aspects and embodiments, should be viewed as intended to be combinable unless the context clearly dictates otherwise.

Although the embodiments disclosed herein have been described with reference to particular embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation. All patents and publications cited herein are incorporated by reference herein for the specific teachings thereof as noted, unless other statements of incorporation are specifically provided.

1. A catalytic article comprising:
a) a first layer comprising at least one first platinum group metal supported on a first support,
wherein the first support comprises an alumina and a first oxygen storage component,
wherein the first oxygen storage component comprises ceria-zirconia;
b) a second layer comprising at least one second platinum group metal supported on a second support,
wherein the second support comprises an alumina and a second oxygen storage component,
wherein the second oxygen storage component comprises ceria-zirconia; and
c) a substrate,
wherein the total amount of alumina, calculated as Al₂O₃, from the first and second layer is ≥1.4 gram per cubic inch of the substrate;
wherein the total amount of ceria, calculated as CeO₂ from the first and the second layer is ≥0.6 gram per cubic inch of the substrate;
wherein the weight ratio of ceria present in the first layer to ceria present in the second layer is > 1.7:1; and
wherein the total amount of first or second platinum group metal is in the range of 0.001 to 0.2 gram per cubic inch of the substrate.

2. The catalytic article according to claim 1, wherein the first or the second platinum group metal is selected from the group consisting of palladium, platinum, and rhodium.

3. The catalytic article according to claim 1, wherein the first platinum group metal is palladium.

4. The catalytic article according to claim 1, wherein the second platinum group metal is rhodium.

5. The catalytic article according to claim 1, wherein the alumina comprises a dopant selected from the group consisting of lanthana, ceria, ceria-zirconia, zirconia, lanthana-zirconia, baria, baria-lanthana, baria-lanthana-neodymia, and combinations thereof.

6. The catalytic article according to claim 1, wherein the amount of ceria in the first oxygen storage component is about 20 to about 45 wt.%, based on total weight of the first oxygen storage component.

7. The catalytic article according to claim 1, wherein the amount of ceria in the second oxygen storage component is about 20 to about 45 wt.%, based on total weight of the second oxygen storage component.

8. The catalytic article according to claim 1, wherein the total amount of alumina from the first and second layer is 1.4 to 2.5 grams per cubic inch of the substrate, and wherein the total amount of ceria from the first and the second layer is 0.6 to 1.0 grams per cubic inch of the substrate.

9. The catalytic article according to claim 1, wherein the weight ratio of ceria present in the first layer to ceria present in the second layer is in the range of about 1.7:1 to about 3.5:1.

10. The catalytic article according to claim 1, wherein the second layer comprises a ceria-zirconia composite.

11. The catalytic article according to claim 1, wherein the first layer comprises at least one alkaline earth metal oxide selected from the group consisting of barium oxide, strontium oxide, and any combination thereof, in an amount of 1.0 to 20 wt. %, based on the total weight of the first layer.

12. The catalytic article according to claim 1, wherein the substrate is a ceramic substrate, metal substrate, ceramic foam substrate, polymer foam substrate or a woven fibre substrate.

13. The catalytic article according to claim 1, wherein the catalytic article comprises:
a) a first layer comprising at least one first platinum group metal in an amount of 0.029 to 0.174 gram per cubic inch of the substrate supported on a first support,
wherein the first platinum group metal is palladium, wherein the first support comprises alumina and the first oxygen storage component comprises ceria-zirconia, and
wherein the amount of ceria is 40 %, based on the total weight of the first oxygen storage component;
b) a second layer comprising at least one second platinum group metal in an amount of 0.001 to 0.017 gram per cubic inch of substrate supported on a second support, wherein the second platinum group metal is rhodium,
wherein the support comprises alumina-ceria and the second oxygen storage component comprises ceria-zirconia, and
wherein the amount of ceria is 40 %, based on the total weight of the second oxygen storage component; and
a) a substrate,
wherein the total amount of alumina from the first and second layer is 1.4 to 2.5 gram per cubic inch of the substrate,
wherein the total amount of ceria from the first and the second layer is 0.6 to 1 gram per cubic inch of the substrate; and
wherein the weight ratio of ceria present in the first layer to ceria present in the second layer is in the range of 1.7:1 to 3.5:1.

14. The catalytic article according to claim 1, wherein the first layer further comprises barium and zirconium; and the second layer comprises ceria-zirconia composite.

15. A process for the preparation of the catalytic article according to claim 1, wherein said process comprises:
preparing a first layer slurry comprising a) at least one first platinum group metal, b) an alumina, and c) a first oxygen storage component comprising ceria-zirconia;
depositing the first layer slurry on a substrate to obtain a first layer;
preparing a second layer slurry comprising a) at least one second platinum group metal, b) an alumina, and c) a second oxygen storage component comprising ceria-zirconia; and
depositing the second layer slurry on the first layer to obtain a second layer followed by calcination at a temperature ranging from 400 to 700° C.,
wherein the step of preparing the first layer slurry or second layer slurry comprises a technique selected from the group consisting of incipient wetness impregnation, incipient wetness co-impregnation, and post-addition.

16. The process according to claim 15, wherein the total amount of ceria from the first layer and second layer is ≥0.6 grams per cubic inch of the substrate and the weight ratio of ceria present in the first layer to ceria present in the second layer is in the range of 1.7:1 to 3.5:1.

17. An exhaust system for internal combustion engines, said system comprising the catalytic article according to claim 1.

18. A method of treating a gaseous exhaust stream comprising hydrocarbons, carbon monoxide, and nitrogen oxide, the method comprising contacting said exhaust stream with the catalytic article according to claim 1.

19. A method of reducing hydrocarbons, carbon monoxide, and nitrogen oxide levels in a gaseous exhaust stream, the method comprising contacting the gaseous exhaust stream with the catalytic article according to claim 1 to reduce the levels of hydrocarbons, carbon monoxide, and nitrogen oxide in the exhaust gas.

20. A method of using the catalytic article according to claim 1, the method comprising purifying with the catalytic article a gaseous exhaust stream comprising hydrocarbons, carbon monoxide, and nitrogen oxide.
